(19) United States
(12) Patent Application Publication
(10) Pub. No.: US 2022/0310041 A1
(43) Pub. Date: Sep. 29, 2022

(54) MUSICAL INSTRUMENT AND SYSTEMS AND METHODS INCLUDING SAME

(71) Applicant: John Lydic, Olmsted Township, OH (US)

(72) Inventor: John Lydic, Olmsted Township, OH (US)

(21) Appl. No.: 17/694,027

(22) Filed: Mar. 14, 2022

Related U.S. Application Data
(60) Provisional application No. 63/164,743, filed on Mar. 23, 2021.

(51) Int. Cl. G10D 3/02; G10D 1/08; G10D 3/06; G10D 3/04

(52) U.S. Cl. CPC G10D 3/02; G10D 1/08; G10D 3/06; G10D 3/04

(57) ABSTRACT

A resonance system for enhancing the acoustic properties of a musical instrument. The musical instrument includes a hollow body including a soundboard, a back, and a side wall positioned between the soundboard and the back of the hollow body, at least one first sound hole positioned in the upper bout and/or waist of the soundboard, and at least one second sound hole positioned in the lower bout of the soundboard.

### TECHNICAL FIELD

The present disclosure relates to a resonance system for a musical instrument. In particular, the present disclosure relates to a resonance system that can enhance the acoustic properties of an instrument body.

### BACKGROUND

Certain instruments, such as acoustic or electric guitars, include a sound hole positioned in the upper bout of the soundboard under the strings of the instrument body. It is desirable to provide instruments with enhanced resonance, including better, different, louder and fuller sound as compared to current instruments. The present disclosure provides for enhanced resonance and alters the sound, volume, projection and dynamic range as compared to current instruments.

### SUMMARY

Provided is a musical instrument comprising a hollow body including a soundboard, a back, and a side wall positioned between the soundboard and the back of the hollow body; at least one first sound hole positioned in the upper bout and/or waist of the soundboard; and at least one second sound hole positioned in the lower bout of the soundboard.

Additionally provided is a resonance system comprising a musical instrument and one or more resonators, the musical instrument comprising a hollow body including a soundboard, a back, and a side wall positioned between the soundboard and the back of the hollow body; at least one first sound hole positioned in the upper bout and/or waist of the soundboard; and at least one second sound hole positioned in the lower bout of a soundboard, wherein the at least one first sound hole and the at least one second sound hole are configured to receive one or more resonators.

Additionally provided is a method of making a musical instrument, comprising providing a hollow body including a soundboard, a back, and a side wall positioned between the soundboard and the back of the hollow body; disposing at least one first sound hole in the upper bout and/or waist of the soundboard; and disposing at least one second sound hole in the lower bout of the soundboard.

### BRIEF DESCRIPTION OF THE DRAWINGS

The present disclosure will be more readily understood from the detailed description of illustrative embodiments presented below considered in conjunction with the attached drawings, of which:

FIG. 1 is a front perspective view of one illustrative embodiment of the musical instrument.

FIG. 2 is a front view of the illustrative embodiment of the musical instrument of FIG. 1.

FIG. 3A is a perspective view of one illustrative embodiment of the resonator.

FIG. 3B is a side view of the illustrative embodiment of the resonator of FIG. 3A.

FIG. 4 is a partial perspective view of an illustrative embodiment of a resonator positioned above a second sound hole in the lower bout of the soundboard of the hollow body of the musical instrument.

FIG. 5 is a partial exploded view of an illustrative embodiment of the musical instrument having multiple second sound holes with multiple resonators of varying lengths, wherein the distal ends of the resonators are positioned in different areas within the hollow body of the musical instrument.

It is to be understood that the attached drawings are for purposes of illustrating the concepts of the disclosure and may not be to scale, and are not intended to be limiting in terms of the number or positioning of sound holes or the range of possible sizes, shapes and/or proportions.

### DETAILED DESCRIPTION

Disclosed is a musical instrument comprising a hollow body including a soundboard, a back, and a side wall positioned between the soundboard and the back of the hollow body, at least one first sound hole positioned in the upper bout and/or waist of the soundboard, and at least one second sound hole positioned in the lower bout of the soundboard.

The at least one second sound hole positioned in the lower bout of the soundboard is configured to produce an altered resonant frequency of the hollow body, in particular of the soundboard, with increased amplitude, greater projection, wider dynamic range, fuller reverberant characteristics and a distinguishable chorus effect, creating a novel sound. The second sound hole may be any shape or size. In certain embodiments, the musical instrument comprises two or more second sound holes. In certain embodiments, the musical instrument comprises three or more second sound holes. In certain embodiments, the musical instrument comprises four or more second sound holes. In certain embodiments, the musical instrument comprises five or more second sound holes.

According to certain embodiments, the musical instrument comprises a neck and a body, wherein one or more strings extend from the neck to the body. According to certain embodiments, the body of the musical instrument is hollow. According to certain embodiments, the body of the musical instrument includes a soundboard, a back, and a side wall positioned between the soundboard and the back of the body. When a string is plucked or multiple strings are strummed, the vibration of the strings is transferred to at least a portion of the soundboard. According to certain embodiments, a bridge is mounted on a top portion of the soundboard. According to certain embodiments, a saddle is mounted on a top portion of the bridge. The upper bout is the portion of the body that is nearest the neck. The lower bout is the portion of the body that is nearest to the string termination at the bridge. The waist is positioned between the upper bout and the lower bout. During use, the vibration of the strings is transferred to at least a portion of the soundboard from which sound emanates.

According to certain embodiments, the at least one first sound hole and/or the at least one second sound hole is substantially circular. According to certain embodiments, the at least one first sound hole and/or the at least one second sound hole is substantially oval-shaped. It should be noted, however, that the at least one first sound hole and/or the at least one second sound hole can be configured in other shapes. According to certain embodiments, the at least one first sound hole and/or the at least one second sound hole has a diameter of about 2-4 inches. It should be noted, however, that the at least one first sound hole and/or the at least one second sound hole can vary in size. According to certain embodiments, the at least one first sound hole has a larger diameter than the at least one second sound hole. According to certain embodiments, the at least one first sound hole has a diameter of about 4 inches, and the at least one second sound hole has a diameter of about 2 inches.

According to certain embodiments, the at least one second sound hole is positioned at the center of the lower bout of the body. According to certain embodiments, the at least one second sound hole is positioned at one or more sides of the lower bout of the body. In other words, the at least one second sound hole is positioned on the bass side lower bout and/or treble side lower bout of the body.

According to certain embodiments, the at least one first sound hole is positioned at the center of the upper bout and/or waist of the body. According to certain embodiments, the at least one first sound hole is positioned at one or more sides of the upper bout of the body. In other words, the at least one first sound hole is positioned on the bass side upper bout and/or treble side upper bout.

Advantageously, a musical instrument comprising a hollow body including a soundboard, a back, and a side wall positioned between the soundboard and the back of the hollow body; at least one first sound hole positioned in the upper bout and/or waist of the soundboard; and at least one second sound hole positioned in the lower bout of the soundboard can be manufactured in a relatively simple and efficient manner with reduced manufacturing and material costs.

According to certain embodiments, the at least one first sound hole and the at least one second sound hole are configured to release sound waves at substantially the same time. During use, when for example, a guitar player plucks a string, strums a chord or plays a song, the disclosed instrument is configured to release contrasting sounds from the upper bout and/or waist and lower bout sound holes, but are perceived as one, creating a chorus effect.

According to certain embodiments, the at least one first sound hole and/or the at least one second sound hole is configured to receive a resonator. According to certain embodiments, the resonator comprises a hollow tube having an open proximal end and an open distal end. The resonator may be cylindrical, conical or curvilinear. It should be noted, however, that the resonator may be any shape, size or length. In certain embodiments, the musical instrument comprises two or more resonators. In certain embodiments, the musical instrument comprises three or more resonators. In certain embodiments, the musical instrument comprises four or more resonators. In certain embodiments, the musical instrument comprises five or more resonators.

According to certain embodiments, a rim extends along at least a portion of the open proximal end of the resonator. According to certain embodiments, the rim is configured to be in adjacent contact with a top portion of the soundboard. The rim of the resonator may be affixed to a top portion of the soundboard with an adhesive or other affixing means. According to certain embodiments, the resonator is configured to extend into the at least one first sound hole and/or the at least one second sound hole so that the distal open end of the resonator is positioned within the hollow body of the musical instrument. According to certain embodiments, the open distal end of the resonator is positioned in the hollow body substantially equidistance from the soundboard and the back of the body. The open distal end of one or more resonators can be positioned anywhere inside the hollow body of a musical instrument. It has been found that varying size sound holes and the position of sound holes on the sound board and varying size and lengths of resonators alters the frequencies and other resonant qualities such as, tone, pitch, warmth, brightness, clarity, sustain, projection and volume. Altering one or more of these parameters can achieve a unique resonant characteristic.

The resonator may be manufactured from a variety of methods and materials. The resonator may be composed of material selected from the group consisting of plastic, rubber, metal, wood, and combinations thereof. In certain embodiments, the resonator is plastic. According to certain embodiments, the resonator is composed of a lightweight, non-porous plastic. In certain embodiments, the resonator is flexible or bendable. In certain embodiments, the resonator is rigid, i.e., it is unable to bend or be forced out of shape. In certain embodiments, the resonator is reconfigurable such that the resonator can be repositioned within the hollow body of a musical instrument. The resonator may be manufactured using an injection molding process, an extrusion process, a vacuum forming process, a rotational molding process, a slushing molding process, a casting process, a spray forming process, a compression molding process, a 3D printing process, or other processes known in the art.

When inserted into the at least one first sound hole and/or the at least one second sound hole, the resonator becomes an extension of the soundboard of the body of the musical instrument. The resonator extends the soundboard of the body directly into the hollow body of the musical instrument. With the soundboard extended into the hollow body of the musical instrument, more air particles are displaced and compressed creating more waves of pressure and greater amplification. The at least one first sound hole and/or the at least one second sound hole fitted with the resonator creates a resonant chamber within the larger hollow body of the musical instrument.

A chorus effect is achieved when the at least one first sound hole is combined with the at least one second sound hole, optionally with an integrated resonator. According to certain embodiments, the combination of the at least one first sound hole and the at least one second sound hole results in a musical instrument configured to impart unique resonant characteristics.

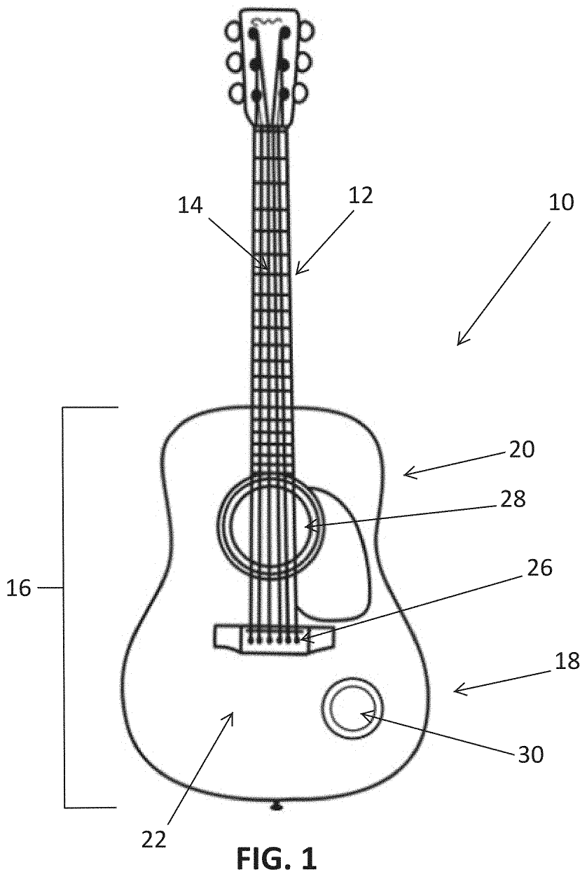

FIG. 1 illustrates a front perspective view of the musical instrument (10), according to embodiments of the present disclosure. Musical instrument (10) comprises a neck (12), wherein one or more strings (14) extend from the neck to a body (16). Body (16) includes lower bout (18) and upper bout (20) portions. Body (12) includes a hollow chamber between a soundboard (22) and a back (not shown). Body (16) further comprises a bridge (26) on a top portion of the soundboard (22) of the body (16). Body comprises a first sound hole (28) opening in the soundboard (22) into the hollow chamber and a second sound hole (30) opening in the soundboard (22) into the hollow chamber. First sound hole (28) is positioned on upper bout (20) portion of body (16). Second sound hole (30) is positioned on lower bout (18) portion of body (16).

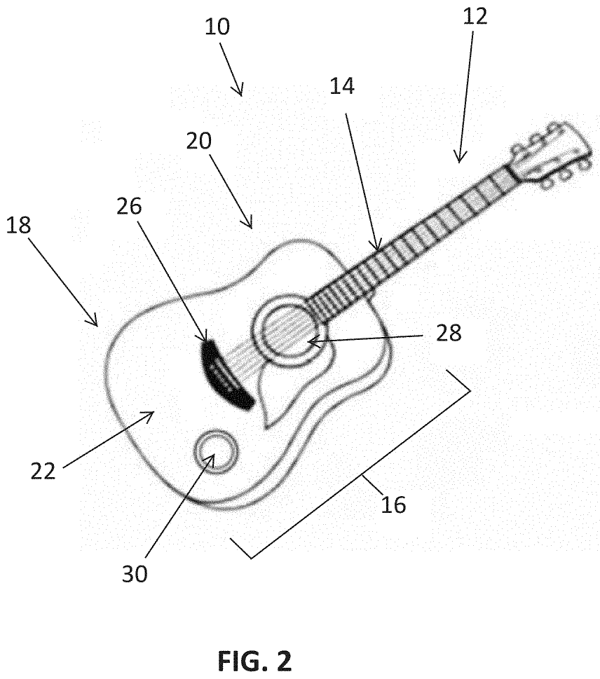

FIG. 2 illustrates a front view of the musical instrument (10) according to embodiments of the present disclosure. Musical instrument (10) comprises a neck (12), wherein one or more strings (14) extend from the neck to a body (16). Body (16) includes lower bout (18) and upper bout (20) portions. Body (12) includes a hollow chamber between a soundboard (22) and a back (not shown). Body (16) further comprises a bridge (26) on the top face of the soundboard (22) of the body (16). Body comprises a first sound hole (28) opening in the soundboard (22) into the hollow chamber and a second sound hole (30) opening in the soundboard (22) into the hollow chamber. First sound hole (28) is positioned on upper bout (20) portion of body (16). Second sound hole (30) is positioned on lower bout (18) portion of body (16).

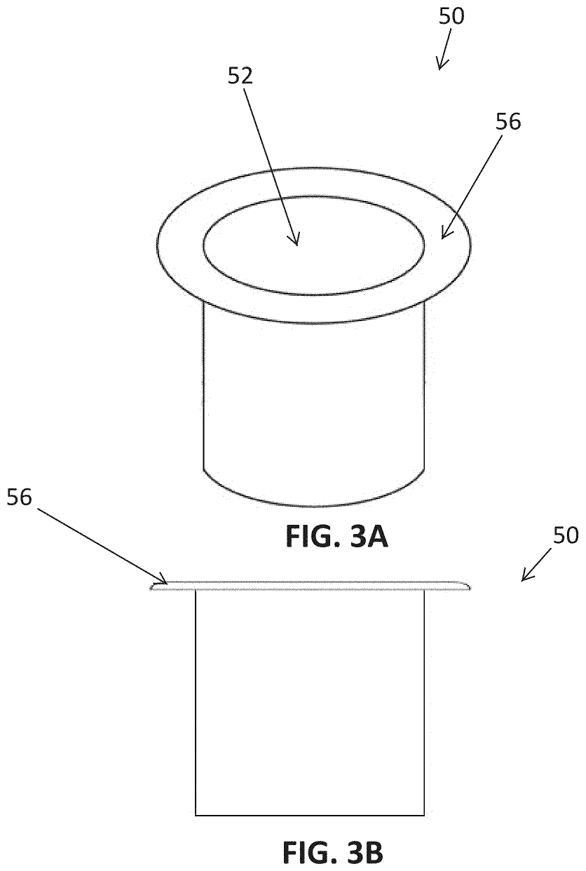

FIG. 3A is a perspective view of one illustrative embodiment of the resonator (50). Resonator (50) comprises a hollow, cylindrical tube having an open proximal end (52) and an open distal end (not shown). A rim (56) extends along at least a portion of the open proximal end (52) of the resonator (50).

FIG. 3B is a side view of the FIG. 3A resonator (50). Resonator (50) comprises a hollow, cylindrical tube having an open proximal end (not shown) and an open distal end (not shown). A rim (56) extends along at least a portion of the open proximal end (52) of the resonator (50).

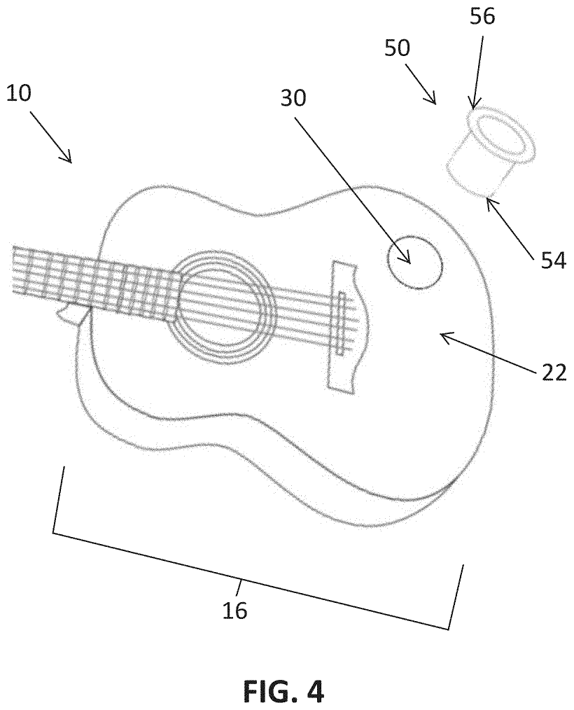

FIG. 4 is a partial perspective view of an illustrative embodiment of the distal end (54) of resonator (50) being positioned inside second sound hole (30) opening of musical instrument (10). Rim (56) of resonator (50) is configured to be in adjacent contact with a top portion of soundboard (22) of body (16) surrounding second sound hole (30) opening. Rim (56) of resonator (50) may be affixed to a top portion of soundboard (22) of the body (16) with an adhesive.

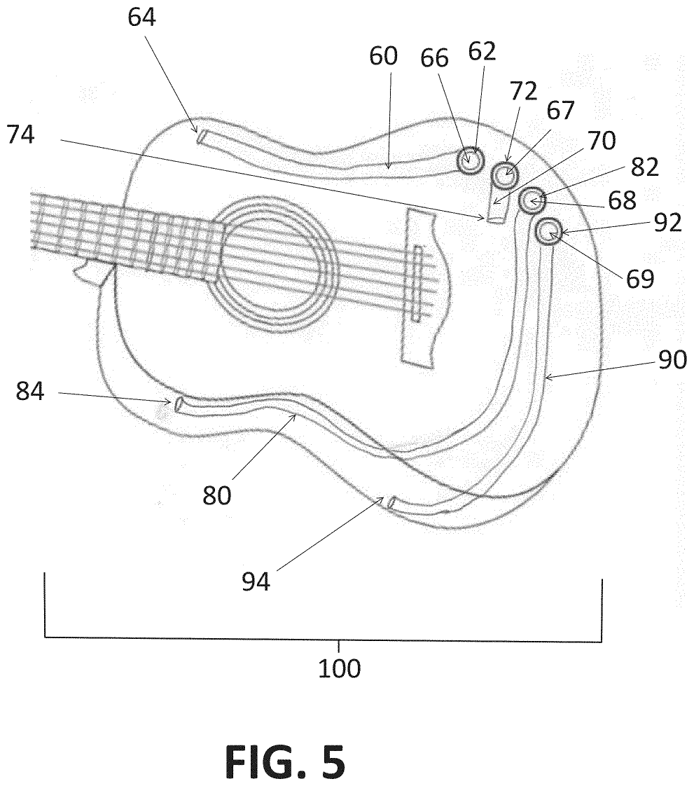

FIG. 5 is a partial exploded view of an illustrative embodiment of the musical instrument (100) according to embodiments of the present disclosure. Musical instrument (100) has multiple second sound holes (66, 67, 68, 69) opening in the soundboard into the hollow chamber. Distal ends (64, 74, 84, 94) of resonators (60, 70, 80, 90) being positioned inside each second sound hole (66, 67, 68, 69) of musical instrument (100). Varying sizes and/or lengths of resonators (60, 70, 80, 90) alters the frequencies and other resonant qualities of musical instrument (100). Distal ends (64, 74, 84, 94) of resonators (60, 70, 80, 90) are positioned in different areas within the hollow body of musical instrument (100) to capture sound waves of varying frequencies. The varying frequencies are then released at proximal ends (62, 72, 82, 92) of the resonators (60, 70, 80, 90) positioned in the lower bout creating a unique sound.

It is to be understood that the exemplary embodiments are merely illustrative of the disclosure and that many variations of the above-described embodiments can be devised by one skilled in the art without departing from the scope of the disclosure. It is therefore intended that all such variations be included within the scope of the following claims and their equivalents.

1. A musical instrument, comprising:
a hollow body including a soundboard, a back, and a side wall positioned between the soundboard and the back of the hollow body;
at least one first sound hole positioned in the upper bout and/or waist of the soundboard; and
at least one second sound hole positioned in the lower bout of the soundboard.

2. The musical instrument of claim 1, wherein the at least one second sound hole produces an altered resonant frequency of the body.

3. The musical instrument of claim 1 further comprising a neck, wherein one or more strings extend from the neck to the body.

4. The musical instrument of claim 1, wherein the at least one second sound hole is substantially circular.

5. The musical instrument of claim 1, wherein the at least one first sound hole and the at least one second sound hole are configured to release sound waves at substantially the same time.

6. The musical instrument of claim 1, wherein the at least one second sound hole is positioned at the center of the lower bout of the body.

7. The musical instrument of claim 1, wherein the at least one second sound hole is positioned at one or more sides of the lower bout of the body.

8. The musical instrument of claim 7, wherein the at least one second sound hole is positioned on the bass side in the lower bout.

9. The musical instrument of claim 7, wherein the at least one second sound hole is positioned on the treble side in the lower bout.

10. The musical instrument of claim 1 comprising at least two second sound holes positioned in the lower bout of the soundboard.

11. The musical instrument of claim 1 comprising at least three second sound holes positioned in the lower bout of the soundboard.

12. The musical instrument of claim 1 further comprising a bridge on a top portion of the soundboard of the body, wherein the at least one second sound hole is positioned below the bridge closest to the string termination in the lower bout.

13. The musical instrument of claim 12, wherein the at least one first sound hole is positioned above the bridge closest to the neck in the upper bout.

14. The musical instrument of claim 1, wherein the at least one first sound hole and/or the at least one second sound hole is configured to receive a resonator.

15. The musical instrument of claim 14, wherein the resonator comprises a hollow tube having an open proximal end and an open distal end.

16. The musical instrument of claim 15, wherein the open proximal end of the resonator comprises a rim extending along at least a portion thereof.

17. The musical instrument of claim 16, wherein the rim is configured to be in adjacent contact with a top portion of the soundboard of the body.

18. The musical instrument of claim 16, wherein the open distal end of the resonator is positioned in the hollow chamber of the body substantially equidistance from the soundboard and the back of the body.

19. A resonance system comprising a musical instrument and a resonator, the musical instrument comprising a hollow body including a soundboard, a back, and a side wall positioned between the soundboard and the back of the hollow body; at least one first sound hole positioned in the upper bout and/or waist of the soundboard; and at least one second sound hole positioned in the lower bout of the soundboard, wherein the at least one first sound hole and/or the at least one second sound hole is configured to receive a resonator.

20. A method of making a musical instrument, comprising providing a hollow body including a soundboard, a back, and a side wall positioned between the soundboard and the back of the hollow body; disposing at least one first sound hole in the upper bout and/or waist of the soundboard; and disposing at least one second sound hole in the lower bout of the soundboard.
